(19) United States
(12) Patent Application Publication
(10) Pub. No.: US 2025/0085433 A1
(43) Pub. Date: Mar. 13, 2025

(54) SYSTEMS AND METHODS FOR GNSS NAVIGATION UTILIZING MULTIPLE PRECISE POINT POSITIONING SERVICES

(71) Applicant: Hemisphere GNSS, Inc., Scottsdale, AZ (US)

(72) Inventors: Jian Ping Chen, Scottsdale, AZ (US); Benjamin Brownlee, Scottsdale, AZ (US); Viet Duong, Scottsdale, AZ (US); Alim Kanji, Scottsdale, AZ (US); Michael Whitehead, Scottsdale, AZ (US)

(73) Assignee: Hemisphere GNSS, Inc., Scottsdale, AZ (US)

(21) Appl. No.: 18/882,679

(22) Filed: Sep. 11, 2024

Related U.S. Application Data
(60) Provisional application No. 63/582,193, filed on Sep. 12, 2023.

(51) Int. Cl. G01S 19/07; G01C 21/00

(52) U.S. Cl. CPC G01S 19/07; G01C 21/005

(57) ABSTRACT

Disclosed are methods, apparatuses, and systems. A method can include receiving, by one or more processors, navigation data from a navigation system. The method can include receiving first correction data from a first correction source and receiving second correction data from a second correction source. The method can include determining first positional data based on the navigation data and the first correction data and second positional data based on the navigation data and the second correction data. The method can include determining a first accuracy value associated with the first positional data and a second accuracy value associated with the second positional data. The method can include selecting one of the first navigation system and the second navigation system for positional tracking based, in part, on at least one of the first accuracy value and the second accuracy value.

### CROSS-REFERENCE TO RELATED PATENT APPLICATIONS

This application claims priority under 35 U.S.C. § 119 to U.S. Provisional Patent Application No. 63/582,193, filed Sep. 12, 2023, the contents of which are hereby incorporated herein by reference in its entirety and for all purposes.

### BACKGROUND

This invention relates generally to a Global Navigation Satellite System (GNSS), and more specifically, to a method, apparatus, and system for improving the accuracy of GNSS systems.

### SUMMARY

In some aspects, the techniques described herein relate to a computer-implemented method including: receiving, by one or more processors, navigation data from a navigation system; receiving, by the one or more processors, first correction data from a first correction source and second correction data from a second correction source; determining, by the one or more processors, first positional data based on the navigation data and the first correction data and second positional data based on the navigation data and the second correction data; determining, by the one or more processors, a first accuracy value associated with the first positional data and a second accuracy value associated with the second positional data; and selecting, by the one or more processors, one of the first correction source and the second correction source for navigational correction based, in part, on at least one of the first accuracy value and the second accuracy value.

In some aspects, the techniques described herein relate to a computer-implemented method, wherein the first accuracy value corresponds to a standard deviation of the first positional data.

In some aspects, the techniques described herein relate to a computer-implemented method, wherein the first accuracy value corresponds to a latency of the first positional data.

In some aspects, the techniques described herein relate to a computer-implemented method, further including: applying, by the one or more processors, a first correction of the first correction data to the first positional data and a second correction of the second correction data to the second positional data.

In some aspects, the techniques described herein relate to a computer-implemented method, further including: receiving, by the one or more processors, a first attribute of the first correction source and the second correction source; and receiving, by the one or more processors, a second attribute of the first correction source and the second correction source.

In some aspects, the techniques described herein relate to a computer-implemented method, wherein the first attribute is a latency of the first positional data and the second positional data and the second attribute is a standard deviation of the first positional data and the second positional data.

In some aspects, the techniques described herein relate to a computer-implemented method, wherein determining the first accuracy value associated with the first positional data includes: determining, by the one or more processors, if the first attribute of the first correction source satisfies a first attribute threshold; responsive to the first attribute of the first correction source not satisfying the first attribute threshold, determining, by the one or more processors, if the first attribute of the second correction source satisfies a second attribute threshold; responsive to the first attribute of the first correction source not satisfying the second attribute threshold, determining, by the one or more processors, if the first correction source is a default correction source; and responsive to determining that the first navigation system is not the default correction source, selecting, by the one or more processors, the second correction system for navigational correction.

In some aspects, the techniques described herein relate to a computer-implemented method, further including: executing, by the one or more processors, a first navigation algorithm using the navigation data and the first correction data and a second navigation algorithm using the navigation data and the second correction data.

In some aspects, the techniques described herein relate to a vehicle including: one or more processors configured to: receive navigation data from a navigation system; receive first correction data from a first correction source and second correction data from a second correction source; determine first positional data based on the navigation data and the first correction data and second positional data based on the navigation data and the second correction data; determine a first accuracy value associated with the first positional data and a second accuracy value associated with the second positional data; and select one of the first correction source and the second correction source for navigational correction based, in part, on at least one of the first accuracy value and the second accuracy value.

In some aspects, the techniques described herein relate to a vehicle, the one or more processors further configured to apply a first correction of the first correction data to the first positional data and a second correction of the second correction data to the second positional data.

In some aspects, the techniques described herein relate to a vehicle, the one or more processors further configured to: receive a first attribute of the first correction source and the second correction source; and receive a second attribute of the first correction source and the second correction source.

In some aspects, the techniques described herein relate to a vehicle, wherein the first attribute is a latency of the first positional data and the second attribute is a standard deviation of the first positional data.

In some aspects, the techniques described herein relate to a vehicle, the one or more processors further configured to, in determining the first accuracy value associated with the first positional data: determine if the first attribute of the first correction source satisfies a first attribute threshold; responsive to the first attribute of the first correction source not satisfying the first attribute threshold, determine if the first attribute of the second correction source satisfies a second attribute threshold; responsive to the first attribute of the second correction source not satisfying the second attribute threshold, determine if the first correction source is a default correction source; and responsive to determining that the first correction source is not the default correction source, select the second correction source for navigational correction.

In some aspects, the techniques described herein relate to a vehicle, the one or more processors further configured to, in determining the first positional data and the second positional data, execute a first navigation algorithm using the navigation data and the first correction data and a second navigational algorithm using the navigation data and the second correction data.

In some aspects, the techniques described herein relate to a system including: a receiver configured to: receive navigation data from a navigation system; receive first correction data from a first correction source and second correction data from a second correction source; and one or more processors configured to: determine first positional data based on the navigation data and the first correction data and second positional data based on the navigation data and the second correction data; determine a first accuracy value associated with the first positional data and a second accuracy value associated with the second positional data; and select one of the first correction source and the second correction source for navigational tracking based, in part, on at least one of the first accuracy value and the second accuracy value.

In some aspects, the techniques described herein relate to a system, wherein the first accuracy value corresponds to a standard deviation of the first positional data.

In some aspects, the techniques described herein relate to a system, wherein the first accuracy value corresponds to a latency of the first positional data.

In some aspects, the techniques described herein relate to a system, the one or more processors further configured to apply a first correction of the first correction data to the first positional data and a second correction of the second correction data to the second positional data.

In some aspects, the techniques described herein relate to a system, the receiver further configured to: receive a first attribute of the first correction source and the second correction source; and receive a second attribute of the first correction source and the second correction source.

In some aspects, the techniques described herein relate to a system, the receiver further configured to execute a first navigation algorithm using the navigation data and the first correction data and a second navigation algorithm using the navigation data and the second correction data.

### BRIEF DESCRIPTION OF THE DRAWINGS

FIG. 1 is a block diagram of an embodiment of the present disclosure, according to some embodiments;

FIG. 2 is a flowchart of a process for selecting and switching from among multiple correction sources, according to some embodiments; and

FIG. 3 is a flowchart for a computer-implemented method, according to some embodiments.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Referring generally to the Figures, the systems, apparatuses, and methods described herein relate to improving the accuracy of Global Navigation Satellite Systems (“GNSS”). GNSS may be used to determine the location and/or attitude of a body (e.g., vehicle, ship, human, etc.). A GNSS may include a network of satellites that broadcast GNSS radio signals. The GNSS radio signals may be used to determine the location of a receiving antenna, the time of signal reception and/or the attitude of a body that has a pair of receiving antennae fixed to it. A location of the receiver can be determined by receiving GNSS signals from multiple satellites in known positions, determining the transmission time for each of the signals, and solving for the position of the receiving antenna based on the known data. In addition to determining the location of a receiver, GNSS systems may also be used to determine the orientation or heading of a body. In such GNSS Attitude or Heading systems, signals arriving at multiple antennas placed at known distances relative to each other may be processed to determine differences in the arrival times of the GNSS signals at each antenna, and the system can use this data to calculate the attitude (orientation) or heading (direction) of the body.

Generally, a GNSS may include a network of satellites that broadcast GNSS radio signals to be utilized in determining the location, position, orientation, and/or direction of a receiving antenna and/or connected body. The GNSS or satellite systems as discussed herein may include, but are not limited to, the Navstar Global Positioning System (GPS), established by the United States; Global Orbiting Navigation Satellite System (GLONASS), established by the Russian Federation; the BeiDou Navigation Satellite System (BDS) created by China; and Galileo, created by the European Community. GNSS systems can be used in various applications for geolocation or navigation (e.g., of vehicles such as cars, boats, farm machinery, airplanes, space vehicles, etc.).

GNSS systems provide satellite-based positioning services through a constellation of satellites. Generally, each GNSS satellite may broadcast signals (e.g., navigation data) where a spreading code and/or data are modulated on a carrier, and the signals transmitted by each GNSS satellite may be received by a receiver. For example, GPS, GLONASS, BeiDou, and Galileo can transmit GNSS radio signals through multiple satellites. The signals transmitted by the GNSS satellites can include data such as orbital information (e.g., ephemeris data) and timing information (e.g., clock data), which are used by GNSS receivers to calculate position, location, direction, orientation, or other information. Typically, a GNSS receiver determines its position by receiving signals from multiple satellites (e.g., at least four) and calculating a time for each signal to travel from the satellite to the receiver. By knowing the speed of light and the time delay for each signal, the receiver can calculate the distance to each satellite. Using the known positions of the satellites, the receiver may then apply techniques such as trilateration, least-squares adjustment, or Kalman filter to compute its own location.

However, GNSS signals can be compromised by various sources of error. The sources of error may include satellite clock offset (e.g., discrepancies arise in the satellite's internal clock, leading to imperfect timing information), orbital errors (e.g., caused by slight deviations in the precise satellite orbit), atmospheric delays (e.g., where the ionosphere and troposphere cause signal refraction or slowing, distorting the time of arrival at the receiver), and multipath interference (e.g., caused by GNSS signals reflecting off surfaces, such as buildings or the ground, before reaching the receiver, leading to inaccurate distance measurements).

To improve accuracy or precision when using GNSS signals, Precise Point Positioning (“PPP”) techniques or services may be implemented. PPP correction services generally provide correction data for GNSS signals to mitigate or correct errors or inaccuracies in the GNSS signals or navigation data (e.g., orbit/clock corrections, code and carrier phase biases, etc.). Correction data from PPP services can be sent over a GNSS system (e.g., via GNSS satellites), by non-GNSS satellites (e.g., communications satellites utilized by a PPP service), and/or over ethernet or other ground-based communications. In some embodiments, satellite correction data may be generated by using a network of continuously operating reference stations (CORS) that track multiple constellations. The correction data transmitted by PPP services may include corrections or correction factors such as clock corrections, orbit corrections, code/phase biases, ephemeris updates, and/or atmospheric delay models. GNSS receivers can use the correction to adjust positional calculations and compensate for various error sources. GNSS receivers (e.g., processors) may apply the correction data based on the type of error being corrected. For example, for satellite clock offset, the receiver may use clock correction factors to correct the satellite's timing information. For orbital inaccuracies, the receiver may utilize improved ephemeris data or corrections to ephemeris data to account for deviations in a predicted position of the transmitting satellite. For atmospheric delays such as ionosphere delays, if the delays are not transmitted to a user, the receiver can use techniques such as ionosphere-free linear combinations for elimination or apply an undifferenced and uncombined PPP model for estimation. In some embodiments, various additional and/or alternative error correction techniques using a variety of correction data may be implemented or applied by a receiver.

Generally, different correction sources (e.g., GNSS systems such as Galileo with corresponding High Accuracy PPP service (HAS), PPP services provided over geostationary satellite L-band links, etc.) have different benefits and drawbacks. For example, one PPP service may provide high accuracy or precision, while another PPP service may provide more reliable signal reception. For example, a first PPP service may use a proprietary system that transmits correction data through geostationary satellites on the L-band. The first PPP service may provide high precision and/or high accuracy but may be vulnerable to signal obstructions due to reliance on geostationary satellites, and may also have longer convergence times depending on environmental conditions. In contrast, a second PPP service may be an open-source or freely available service, such as a PPP service transmitting correction data through medium Earth orbit (“MEO”) GNSS satellites. In this example, the second PPP service may provide more reliable signal reception because MEO satellites provide wide coverage and reduce the likelihood of signal blockage, and may provide shorter convergence times, potentially reducing the time to achieve positioning accuracy. However, while the second PPP service may provide more reliable coverage and/or larger coverage, the accuracy or precision of the second PPP may be lower than the accuracy/precision of the first PPP service. Thus, it may be advantageous to alternate between multiple PPP services or other correction sources for navigation, depending on various conditions and/or characteristics of an operating environment and/or the PPP services.

In an embodiment of the present disclosure, the strengths of certain correction sources may be combined to attenuate the weaknesses of other correction sources to provide an improved GNSS system. For example, a receiver may utilize a selected correction source based on a real-time analysis of multiple correction sources available and dynamically switch among correction sources to improve GNSS performance. More specifically, in an embodiment, the receiver supports receiving and evaluating multiple correction sources in parallel by running or executing a PPP navigational solution for each correction source (e.g., a first PPP and a second PPP). After the multiple correction sources have been received and processed in an associated navigational solution, the receiver can make an evaluation of which navigation solution and associated correction source is to be selected to deliver the receiver's reported position. The selection may be based on various factors, including, but not limited to, accuracy, precision, and/or conversion times associated with each of the multiple correction sources. Further, the receiver may utilize decision-making logic to dynamically switch between multiple PPP navigational solutions utilizing different correction sources, improving the accuracy and reliability of geo-location services implementing GNSS corrections. By dynamically selecting between PPP navigation systems utilizing different correction sources based on parameters such as accuracy or other data or operating conditions, the methods, apparatuses, and systems disclosed here provide improvements to navigation systems by increasing reliability and accuracy of the position solution. For example, by alternating between a high-accuracy PPP service with a high-reliability PPP service, a navigation system can continuously provide accurate and consistent positioning under varying conditions.

Referring generally to the Figures, disclosed are methods, apparatuses, and systems improving GNSS signal accuracy or reliability. Some embodiments relate to a method including receiving navigation data from one or more navigation systems. The method may include receiving first correction data from a first correction source and second correction data from a second correction source. The method may further include determining first positional data based on the navigation data and the first correction data and second positional data based on the navigation data and the second correction data. The method may further include determining a first accuracy value associated with the first positional data and a second accuracy value associated with the second positional data. The method may further include selecting one of the first correction source and the second correction source for navigational correction based, in part, on at least one of the first accuracy value and the second accuracy value.

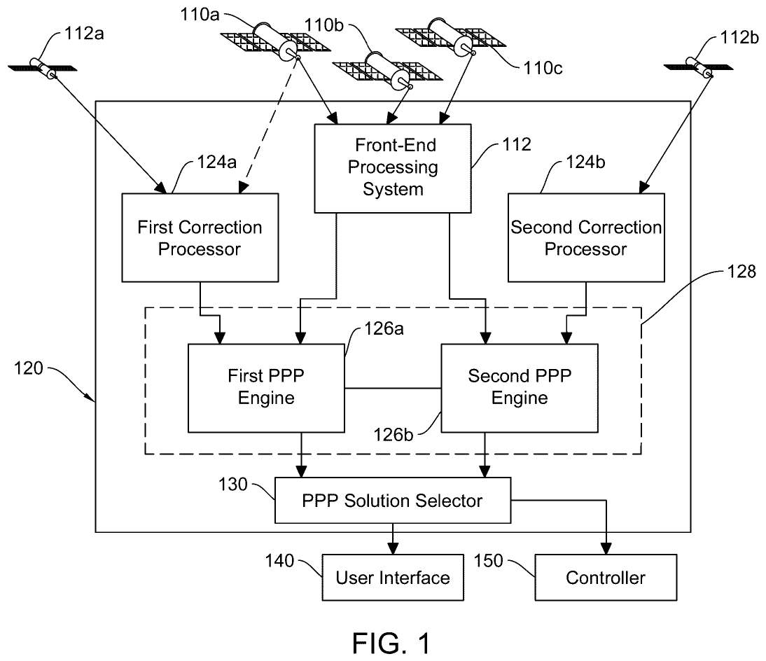

Referring now to FIG. 1, a block diagram of a system for navigation and navigational correction is shown. For example, the embodiment shown in FIG. 1 may include navigation satellites 110a-110c (collectively, satellites 110), correction sources 112a-112b (collectively, correction sources 112), a receiver 120, a user interface 140, and a controller 150. The receiver 120 may include a front-end processing system 122, a first correction processor 124a and a second correction processor 124b (collectively, correction processors 124), a navigation processor 128 including PPP engines 126a-126b (collectively, PPP engines 126), and a PPP solution selector 130. Generally, the elements or systems of FIG. 1 (e.g., navigation satellites 110, receiver 120, etc.) can include one or more processors and/or non-transitory memory containing instructions that when executed by the one or more processors, cause the one or more processors to execute one or more steps of the methods described herein.

In some embodiments, the satellites 110 can include GNSS satellites. For example, the satellites 110 can be Galileo satellites, QZSS satellites, and/or other GNSS satellites. In some embodiments, the correction sources 112 can include communications satellites or other communication links delivering correction services. For example, one or more of the correction sources 112 (e.g., correction source 112b) can be a communication satellite of a PPP service such as, for example, Atlas® PPP service. In another example, one or more of the correction sources 112 (e.g., correction source 112a) can be a satellite of GNSS system (e.g., Galileo HAS) providing correction data and navigation data to the receiver 120. For example, the correction source 112a can include the satellite 110a, which can transmit correction data to the correction processor 124a and navigation data to the front-end processing system 122. Generally, the satellites 110 and/or the correction sources 112 can send or transmit navigation data, corrections, or other information to the receiver 120. For example, the satellites 110 may transmit navigation data including orbital information, timing offset information, and/or corrections corresponding to the satellites 110 and/or an associated navigation system (e.g., GNSS system).

In some embodiments, the receiver 120 can include a GNSS receiver. That is, the receiver 120 can be configured to receive GNSS signals from satellites 110, which may include satellites from one or more GNSS systems (e.g., GPS, Galileo, GLONASS, and/or BeiDou) and/or satellites or other correction sources associated with a PPP service. In some embodiments, the receiver 120 can include electronics or systems not depicted in FIG. 1, such as input/output (I/O) units, antenna(s), or processing systems for receiving and/or processing GNSS signals or data transmitted by PPP services. Generally, the receiver 120 can receive and process GNSS signals (e.g., navigation data) and/or PPP signals (e.g., correction data) from the satellites 110 and apply techniques such as pseudorange and carrier-phase measurements and trilateration (e.g., using a least-squares adjustment, Kalman filter, etc.) to determine the location, direction, orientation, or other information associated with the position of the receiver 120. Further, the receiver 120 can be configured to apply various correction techniques to improve the accuracy of received GNSS signals by compensating for errors such as satellite clock drift, orbital deviations, and atmospheric delays using the correction data.

In some embodiments, the receiver 120 can include various sub-systems for receiving and/or processing navigation data or correction data. For example, the front-end processing system 122 can be configured to receive and process navigation data from the satellites 110 (e.g., navigation systems). In some embodiments, the front-end processing system 122 can track (e.g., record, store, etc.) and/or convert data or signals received from the satellites 110 from analog form to digital form and provide the data or signals in digital form to the correction processors 124. In some examples, the front-end processing system 122 can include a radio-frequency (RF) front end.

In some embodiments, the correction processors 124 can be configured to receive and process positional data. That is, the correction processor 124a can receive and process correction data from a first correction source (e.g., correction source 112a), and the correction processor 124b can receive and process positional data from a second correction source (e.g., correction source 112b) in parallel. The correction processors 124 can further provide the corrections to the navigation processor 128 and/or PPP engines 126.

In some embodiments, the navigation processor 128 and/or PPP engines 126 can be configured to receive navigation data (e.g., processed GNSS signals) from the front-end processing system 122 and to receive correction data (e.g., corrections) from the correction processors 124. Further, the navigation processor 128 and/or PPP engines 126 can analyze the received navigation data and correction data, determine or identify one or more corrections of the correction data to apply to the positional data, and apply the corrections to generate corrected navigation data (e.g., positional data). For example, the PPP engine 126a can determine and apply one or more corrections included in correction data received from the correction source 112a to apply to navigation data received from satellites 110 via the front-end processing system 122, and the PPP engine 126b can determine and apply one or more corrections included in correction data received from the correction source 112b to the navigation data.

In some embodiments, the navigation processor 128 and/or PPP engines 126 can be configured to receive and process navigation data and corrections transmitted by the correction processors 124 and/or the front-end processing system 122. For example, the PPP engine 126a can receive correction data from the correction processor 124a, and the PPP engine 126b can receive correction data from the correction processor 124b. Both PPP engine 126a and PPP engine 126b can operate in parallel, generating independent PPP solutions based on the correction data received from the correction processor 124a and the correction processor 124b, respectively, and the navigation data received from the front-end processing system 122. That is, the PPP engines 126 can apply the corrections received from the correction processors 124 to perform calculations for improving the positional accuracy of the GNSS signal data (e.g., navigation data). For example, PPP engine 126a can generate a first PPP solution (e.g., corrected output or positional data) based on the corrections applied to the navigation data received from the navigation system associated with satellites 110, while PPP engine 126b can generate a second PPP solution based on the corrections applied to the navigation data received from the satellites 110 of the navigation system. In some embodiments, PPP engine 126a and PPP engine 126b may generate respective PPP solutions (e.g., corrected positional output) and provide the PPP solutions to the PPP solution selector 130 for further evaluation and selection.

In some embodiments, the receiver 120 can include a broadcast ephemeris processor (not shown) configured to receive and process ephemeris data from satellites 110. Generally, ephemeris data may include orbital parameters, timing updates, and/or other data used to compute satellite trajectories or GNSS satellite clock errors. The broadcast ephemeris processor can receive and further transmit ephemeris data to both PPP engine 126a and PPP engine 126b, which may use the ephemeris data in conjunction with the correction data received from the correction processors 124 to refine PPP solutions. In some embodiments, the front-end processing system 122 can be configured to receive ephemeris data. Generally, the correction data from the correction processors 124 can be applied to correct errors such as clock errors, satellite code and phase biases, atmospheric delays, and errors in the broadcast ephemeris (e.g., included in the navigation data, received via the broadcast ephemeris processor, etc.) provides updated satellite clock offset and satellite orbital data, which may better reflect an actual position or trajectory of an associated satellite.

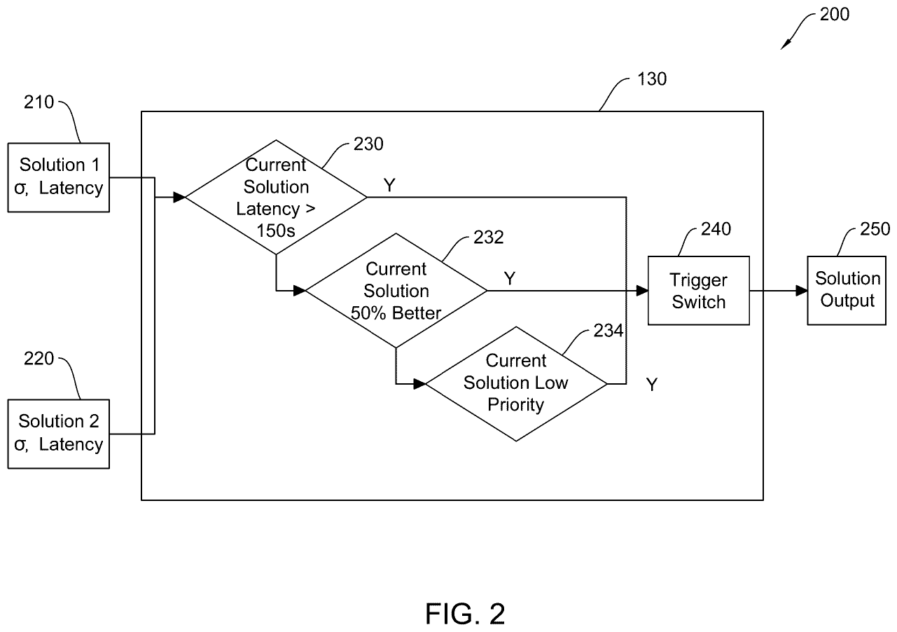

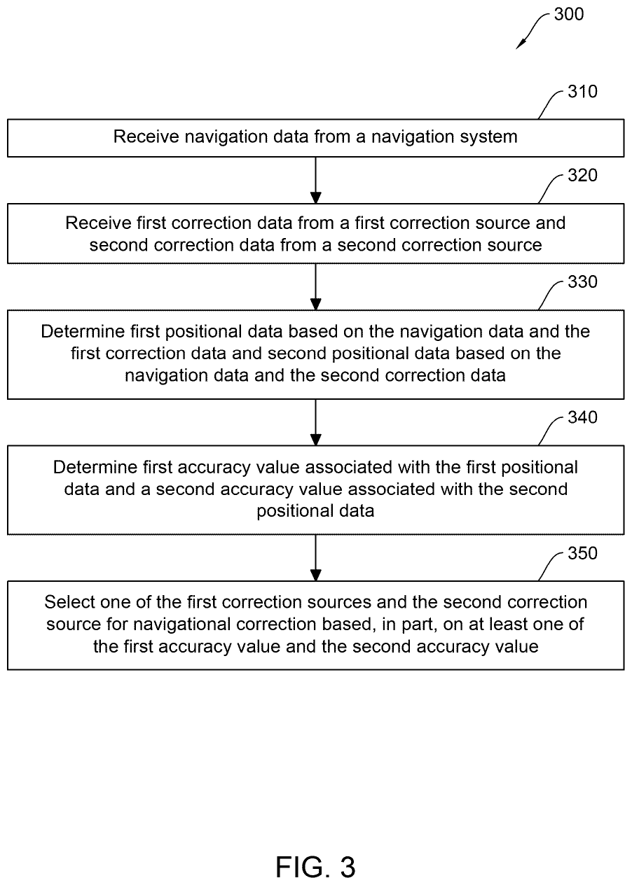

In some embodiments, the PPP solution selector 130 can be configured to receive PPP solutions from the navigation processor 128 and/or PPP engine 126a and PPP engine 126b. The PPP solution selector 130 can evaluate the accuracy and performance of the PPP solutions and/or select a PPP solution or associated correction source 112 for navigational correction based on accuracy values, which may include attributes or combinations of attributes such as standard deviations and latencies. The PPP solution selector 130 may prioritize or select the PPP solution that provides a highest estimated accuracy value, such as a lowest estimated deviation (e.g., a lowest standard of deviation of positional data outputted by navigation processor 128) or latency (e.g., a lowest latency of the correction data). For example, the PPP solution selector 130 can compare the accuracy values and/or attributes associated with the PPP solution generated by PPP engine 126a, which processes correction data from the first correction source (e.g., correction source 112a), with the accuracy values and/or attributes associated with the PPP solution generated by PPP engine 126b, which processes correction data from the second correction source (e.g., correction source 112b). The PPP solution selector 130 may further compare both PPP solutions or associated accuracy values/attributes to various thresholds (e.g., attribute thresholds such as maximum latency limits, etc.). Based at least in part on the accuracy values and/or attributes, the PPP solution selector 130 can determine a PPP solution for selection and output the selected positional data for further processing or display on the user interface 140. In some embodiments, the PPP solution selector 130 can provide the positional data and/or selected correction source to the user interface 140. Additional details regarding the evaluation process and the selection criteria are described with regard to FIG. 2 and FIG. 3.

In some embodiments, the user interface 140 can include a graphical user interface (GUI) that displays or provides selected positional data (e.g., to a user). In some embodiments, the user interface 140 can display user-interactive elements and content. The interactive elements may include various controls, such as buttons, input fields, and menus, that are selectable by a user to interact with the user interface 140. The content displayed by the user interface 140 may include positional data, correction data/sources, maps, system status indicators, and other graphics or information associated with the position or operation of the receiver 120 and/or other components of FIG. 1 (e.g., satellites 110). In some embodiments, the user interface 140 can output the positional data selected by the PPP solution selector 130, and may further display the selected positional data using alphanumerical coordinates, graphical indicators, and/or maps. Further, the user interface 140 may provide options for user input to adjust system functionality, including selecting different views, updating settings, or modifying the display of the selected positional data. In some embodiments, the user interface 140 can also display system status information (e.g., connection status with satellites 110, performance of the PPP solution selector 130, etc.). Additionally, the user interface 140 may output notifications or alerts (e.g., warnings if positional accuracy falls below a certain threshold or if signal latencies increase). The user interface 140 may be integrated into other systems, such as a controller of navigation system of a vehicle (e.g., controller 150), for navigation and/or navigational correction.

In some embodiments, the receiver 120 can be integrated into vehicle including controller 150 to provide positional tracking, navigational correction, or other location-based functionalities. The receiver 120 can be installed within, and/or in communication with, the controller 150 of the vehicle, where the receiver 120 interfaces with various onboard components of the vehicle via the controller 150, such as navigation systems, sensors, and actuators, to supply positional data for guiding vehicle operations. For example, in an agricultural vehicle, the receiver 120 can provide location data to cause the controller 150 to automate tasks such as plowing, planting, or harvesting and coordinate with systems responsible for steering, speed, and otherwise implementing adjustments in the operation of the vehicle. The receiver 120 and controller 150 can also be used in a variety of other systems or vehicles, such as autonomous cars, where the receiver 120 manages route planning and interacts with the controller 150 for autonomous driving. More broadly, the receiver 120 can be included within any suitable body including the controller 150, including stationary or mobile platforms, industrial machinery, with users or user devices, or autonomous systems to provide accurate positional data for various applications such as geo-location and positional tracking, route optimization and automation, and equipment monitoring.

In some embodiments, the receiver 120 can include one or more decoder data alignment quality control systems (not shown). Generally, the decoder data alignment quality control systems may include systems or processing units for decoding or interpreting GNSS signals. Further, the decoder data alignment quality control systems may perform preprocessing, validation, or other quality control operations to refine received positional data, improve data quality, and prepare the data for applying corrections. For example, the decoder data alignment quality control systems may decode signals from a first correction source, such as L-band signals, and signals from a second correction source, which may operate on different frequency bands or use different signal formats. Responsive to decoding, the decoder data alignment quality control systems can check positional data for data consistency, verify timing alignment, and identify potential discrepancies in the incoming positional data from navigation systems. In some embodiments, the decoder data alignment quality control systems can determine, calculate, or identify accuracy values and/or attributes corresponding to navigation data embedded in signals received by the front-end processing system 122 and/or correction processors 124 (e.g., latency of signals, standard deviation of positional data, etc.). In some embodiments, the decoder data alignment quality control systems can receive corrections. For example, the decoder data alignment quality control systems can process received positional data using corrections or prepare the received positional data for further processing (e.g., application of corrections by another system or device).

In some embodiments, the corrections provided by correction sources 112 can include various correction factors to improve the accuracy of the navigation data received from the GNSS satellites. For example, first correction data can be associated with the first correction source 112a and may include a first set of orbit corrections, clock corrections, code/phase biases, and/or atmospheric corrections to be applied to the navigation data received from satellites 110. Similarly, second correction data can be associated with the second correction sources 112b and may include a second set of orbit corrections, clock corrections, code/phase biases, and/or atmospheric corrections to be applied to the navigation data.

In some embodiments, the receiver 120 may include a PPP correction interface (not shown) configured to receive outputs from internal processing systems of the receiver 120 (e.g., correction processors 124, decoder data alignment quality control systems, etc.). In some examples, the PPP correction interface can process or prepare received navigation data and corrections for transmission to the PPP engines 126a and 126b. Further, the PPP correction interface may be used for applying corrections or for providing user input or instructions related to the navigation data or corrections.

It should be understood that, although the receiver 120 is illustrated as including two processing systems (e.g., parallel systems) for navigational correction from a first and a second correction source, (e.g., a first system including correction processor 124a and PPP engine 126a and a second system including correction processor 124b and PPP engine 126b), the receiver 120 may include any number of processing systems to receive and process data and/or signals from any number of correction sources (e.g., a third correction processor and PPP engine for a third correction source, etc.). Further, the various components of FIG. 1 (e.g., receiver 120, PPP solution selector 130) may be configured for navigational correction using any number of correction sources. For example, the PPP solution selector 130 can select from three, four, or any number of correction sources, as described above regarding the first correction source 112a and the second correction source 112b, or otherwise.

Referring now to FIG. 2, a flowchart of a process 200 for selecting and switching from among multiple correction sources is shown. As a general overview, the process 200 can include receiving a first PPP solution at block 210 and receiving a second PPP solution at block 220. The process 200 can include determining or comparing accuracy values or attributes at block 230 and block 232. At block 234, the process 200 may include determining a selection preference. Depending on the results of determinations or comparisons of block 230, block 232, and block 234, the process 200 may include repeating one or more blocks (e.g., block 230) or advancing to block 240 and triggering a switch (e.g., of navigation systems). The process 200 may further include outputting a solution at block 250. Generally, the process 200 may be performed by any system or component of FIG. 1 (e.g., receiver 120) and/or by one or more processors. In some embodiments, the process 200 may be performed by PPP solution selector 130.

In some embodiments, the process 200 can include receiving the first PPP solution at block 210 and the second PPP solution at block 220. For example, the PPP solution selector 130 may be configured to receive the first PPP solution, which corresponds to positional data derived from applying a first set corrections to navigation data received from a navigation system (e.g., GNSS system). The first PPP solution may include the corrected positional data and be calculated based on signals received from the navigation system. Similarly, the second PPP solution, received at block 220, may correspond to positional data derived from applying a second set of corrections to the navigation data. The PPP solution selector 130 can receive both solutions in parallel, where the first and second PPP solutions may represent independent positioning solutions derived from different sets of satellites or correction services. Each of the PPP solutions may include accuracy values, such as latency, standard deviation, or other parameters that define the reliability or precision of the corresponding positional data.

In some embodiments, the process 200 can include determining accuracy values and/or attributes at block 230 and/or block 232. For example, responsive to receiving the first and second PPP solutions, the PPP solution selector 130 may determine accuracy values or attributes associated with the first PPP solution at block 230 and may determine accuracy values or attributes associated with the second PPP solution at block 232. In some examples, the accuracy values may include various attributes or parameters corresponding to a PPP solution, other correction source, or associated navigation system, or may be a calculation (e.g., composite score) of one or more attributes of a given PPP solution, other correction source, or associated navigation system. For example, an accuracy value of the first correction source or first positional data derived using the correction data from the first correction source may include a first attribute including the latency of the signals associated with the correction source or navigation system. Further, the accuracy value of the first correction source or first positional data may include a second attribute including the standard deviation of the positional data derived from the navigation data. Similarly, a first attribute of the second correction source can include a latency associated with the second correction source or navigation system, and a second attribute of the second correction source can include a standard deviation of the positional data.

Still referring to block 230 and/or block 232, the process 200 can include determining whether the accuracy values or attributes satisfy thresholds (e.g., standards, minimums or maximums, other parameters, etc.). For example, the PPP solution selector 130 can determine whether the first correction source (e.g., a currently used correction source) satisfies a threshold associated with an accuracy value or attribute at block 230 and/or determine whether the second navigation system satisfies a threshold associated with an accuracy value or attribute at block 232. For example, if the PPP solution selector 130 determines that the latency of the first PPP solution satisfies (e.g., exceeds) an attribute threshold of 150 seconds at block 230, the PPP solution selector 130 may proceed to block 234 to evaluate whether switching to the second PPP solution is preferable. If the first attribute (e.g., latency) does not to satisfy the attribute threshold at block 230 (e.g., has a latency less than 150 seconds), the process 200 may further proceed to block 232. Although a latency threshold of 150 seconds is described herein, it is understood that any suitable latency threshold higher or lower than 150 seconds may be used while still falling within the bounds of the methods and systems described herein. Furthermore, although the latency is described as “satisfying” a threshold when the latency is above the latency threshold, likewise, the latency may be described as “satisfying” the threshold when the latency is below the threshold without departing from the methods and systems described herein.

At block 232, the PPP solution selector 130 may determine or evaluate accuracy values including attributes associated with the second PPP solution. For example, the accuracy values for the second PPP solution may include a second attribute, such as the latency corresponding with the second PPP solution or a standard deviation associated with the second PPP solution. Further, the PPP solution selector 130 may compare the accuracy values or attributes associated with the first PPP solution to the accuracy values or attributes associated with the second PPP solution. That is, both accuracy values (e.g., corresponding to the first and second attributes of each of the first and second correction sources) may be compared against one another or against other thresholds to evaluate the performance and reliability of the respective correction sources for navigational correction. For example, if the first attribute of the first PPP solution does not meet the attribute threshold (e.g., if the latency of the first solution is greater than 150 seconds), the process 200 may proceed to evaluate the second attribute of the second PPP solution at block 234. In one example, if the second PPP solution exhibits a 50% improvement in accuracy compared to the first PPP solution (e.g., lower latency or lower standard deviation of positional data), the PPP solution selector 130 may determine that switching to the second navigation system is preferable. Generally, the PPP solution selector 130 may determine that switching is preferable by evaluating whether the second attribute (e.g., latency or accuracy) of the second PPP solution exceeds a threshold that indicates the second solution is more reliable than the first solution. For example, if the second solution satisfies the attribute threshold (e.g., providing 50% better accuracy or reliability), the process 200 may proceed to block 240 to trigger a switch between navigation systems. If the second solution does not meet the threshold, the process 200 may return to block 232 or block 230 for further evaluation or to analyze additional attributes of the current solution.

In some embodiments, the process 200 may include optionally determining a selection preference at block 234. For example, the PPP solution selector 130 may determine whether the current PPP solution (e.g., correction source) is a default solution or correction source or otherwise assigned a priority status at block 234. Generally, the PPP solution selector 130 may apply a selection preference based, in part, on accuracy values, attributes or criteria corresponding to each of the first or second correction sources and positional data. For example, the PPP solution selector 130 may determine a default setting within a system or a preference for using certain correction sources under particular conditions (e.g., a first correction source being assigned as a default, a second correction source being assigned for use in poor weather, etc.). If the current solution is designated as a default or preferred navigation system, the process 200 may return to block 232 to evaluate or re-evaluate the accuracy values or attributes of the current solution. That is, responsive to determining the first navigation system is a default at block 234, the process 200 may further include re-checking latency values, positional accuracy data, or attributes or accuracy values to confirm that the current solution remains suitable for use at block 232. If the current solution is not the default or does not hold priority status, the process 200 may proceed to block 240.

In some embodiments, the process 200 may include triggering a switch at block 240. For example, the PPP solution selector 130 may trigger or cause a switch between correction sources (e.g., PPP solutions) based on the evaluation of accuracy values or attributes. The PPP solution selector 130 may initiate the switch to the second correction source or PPP solution if it determines that the second PPP solution provides better accuracy or performance compared to the first PPP solution and/or if the difference in performance between the first and second PPP solutions satisfies a value or threshold. For example, if the latency of the second solution is significantly lower (e.g., 50% less latency) than the latency of the first solution, the PPP solution selector 130 may switch or alternate from using the first PPP solution to the second PPP solution. Additionally or alternatively, in a non-limiting embodiment, if the standard deviation of the second solution is significantly lower (e.g., 50% less deviation) than the standard deviation of the first solution, the PPP solution selector 130 may switch or alternate from using the first PPP solution to the second PPP solution. In some embodiments, the process 200 may involve switching between multiple navigation systems or PPP services, depending on the availability and accuracy of signals from each system such that the accurate and reliable data is continuously available for positional tracking and navigational correction. While only two PPP solutions are illustrated in FIG. 2 for case of description, it is understood that any number of PPP solution systems may be employed within the framework of the methods and systems described herein.

In some embodiments, the process 200 may include outputting a solution at block 250. That is, the PPP solution selector 130 can provide or output the selected PPP solution, navigation system, positional data, and/or corrections. The output may be used for further processing or display to a user. For example, the selected solution may be provided to a user interface, such as user interface 140, where the positional data is displayed to a user in the form of numerical coordinates, graphical indicators, or maps. Additionally, the user interface may provide user input options to adjust or interact with the displayed positional data, such as selecting different views or updating system settings. The selected PPP solution may also be integrated into other systems (e.g., vehicles, farm equipment, mobile electronics, etc.) for further navigation, mapping, or positional tracking, as described above regarding FIG. 1.

Referring now to FIG. 3, a flowchart for a computer-implemented method 300 is shown. In a broad overview, the method 300 may include receiving navigation data at block 310, receiving correction data at block 320, determining positional data at block 330, determining accuracy values at block 340, and selecting a correction source at block 350. Generally, the method 300 may be performed by any system or component of FIG. 1 (e.g., receiver 120, PPP solution selector 130, etc.) and/or by one or more processors.

In some embodiments, the method 300 may include receiving navigation data at block 310. For example, one or more processors may receive navigation data from a navigation system (e.g., GNSS system). That is, block 310 may include the receiver 120 or front-end processing system 122 capturing GNSS signals broadcasted using various navigation systems and associated satellites (e.g., satellites 110). For example, the GNSS signals may include navigation data such as satellite orbital information, timing data, and correction data used for determining the position of the receiver. In some examples, the receiver 120 may use front-end processing system 122 to preprocess or prepare the signals for further corrections, accuracy evaluations, or positional determinations.

In some embodiments, the method 300 may include receiving correction data at block 320. For example, one or more processors may receive first correction data from a first correction source and second correction data from a second correction source. That is, block 320 may include the receiver 120 receiving signals including data corresponding with corrections from multiple sources broadcasted using GNSS satellites, PPP service satellites, or ground-based stations. For example, receiving the correction data at block 320 may include the correction processor 124a receiving first corrections to apply to navigation data received via front-end processing system 122. Further, receiving the correction data at block 320 may include the correction processor 124b receiving second corrections to apply to the navigation data.

In some embodiments, the method 300 may include determining positional data at block 330. For example, one or more processors may determine first positional data based on the navigation data and the first correction data and second positional data based on the navigation data and the second correction data. That is, block 330 may include the receiver 120 processing the navigation data in combination with the correction data. For example, the PPP engines 126a and 126b may apply first and second correction data, respectively, to compensate for errors such as signal delays, satellite clock drift, and atmospheric interference in the received navigation data. For example, the PPP engine 126a may adjust the navigation data by using first corrections to refine the navigation data, and the PPP engine 126b may similarly apply second corrections to refine the navigation data. Generally, the receiver 120 can use the correction data to modify timing and position information in the navigation data and refine the navigation data to provide a positional data output (e.g., for positional tracking).

In some embodiments, the method 300 may include determining accuracy values at block 340. For example, one or more processors may determine a first accuracy value associated with the first positional data and a second accuracy value associated with the second positional data. That is, block 340 may include assessing the accuracy of the positional data derived using corrections from the first and second correction sources by analyzing various metrics. The accuracy values can be based on factors such as the standard deviation of the positional data, the latency of the received signals, or any corrections applied to the data. For example, PPP engine 126a may generate a first accuracy value corresponding to positional data generated by applying first corrections data, while PPP engine 126b may generate a second accuracy value for the positional data generated by applying second corrections data. The accuracy values and attributes can be compared to thresholds or to other accuracy values or attributes to determine which correction source provides higher accuracy or lower errors.

In some embodiments, the method 300 may include selecting a correction source at block 350. For example, one or more processors may select one of the first correction source and the second correction for navigational correction based, in part, on at least one of the first accuracy value and the second accuracy value. That is, block 350 may include the PPP solution selector 130 evaluating the accuracy values associated with the positional data derived by applying each of the corrections to determine which correction source provides higher accuracy or more reliable data. For example, the receiver 120 can select a correction source system by comparing the accuracy values against criteria or thresholds, such as maximum acceptable latency or standard deviation limits. For example, if the first correction source has a lower latency and better accuracy compared to the second correction source, the PPP solution selector 130 may select the first navigation system for current navigational correction. In some embodiments, the receiver 120 may evaluate additional factors or attributes, such as signal availability, the number of corrections applied, or environmental conditions to select a correction source.

In some embodiments, the first accuracy value corresponds to a standard deviation of the first positional data. For example, the standard deviation of the first positional data may reflect the consistency of the data outputted by applying the first corrections to the location data, with a lower standard deviation indicating more stable or reliable positional data. In some embodiments, the first accuracy value corresponds to a latency of the first positional data. For example, the latency may reflect the time delay between when a signal is transmitted by the first correction source or navigation system and when the signal is received by the receiver 120. A lower latency value may indicate quicker updates to data. Similarly, the second accuracy value may correspond to a standard deviation and/or latency associated with the second correction source.

In some embodiments, the method 300 may further include applying, by the one or more processors, a first correction of the first correction data to the first positional data and a second correction of the second correction data to the second positional data. For example, the navigation processor 128 or PPP engine 126a may apply one or more orbit corrections, clock corrections, or atmospheric corrections to the first positional data received from the first navigation system. Similarly, the navigation processor 128 or PPP engine 126b may apply one or more corrections to the second positional data received from the second navigation system. In some examples, the navigation processor 128 may output the positional data for selection at block 350. Generally, the corrections may correct errors such as satellite clock drift, orbital deviations, satellite code/phase biases, and/or atmospheric delays to improve the accuracy of the navigation data received by the receiver 120 and associated positional output.

In some embodiments, the method 300 may further include receiving, by the one or more processors, a first attribute of the first correction source and a second attribute of the second correction. For example, the receiver 120 may receive navigation data or corrections, which can include attributes corresponding to the quality, reliability, or availability of the data. Further, the PPP solution selector 130 can evaluate the first and second attributes to determine which correction source provides better performance. For example, the PPP solution selector 130 may compare the latency associated with the first correction source with the latency associated with the second correction source, or compare the standard deviation of the positional output from applying the first correction data with the standard deviation of the positional output from applying the second correction data to select the correction source providing more accurate or stable positional outputs.

In some embodiments, the first attribute is a latency of the positional data, and the second attribute is a standard deviation of the positional data. For example, the PPP solution selector 130 within the receiver 120 may evaluate the latency of the signals received from the correction sources 112 as a component of the accuracy value associated with the correction sources 112. The PPP solution selector 130 may also evaluate the standard deviation of the positional data derived by applying corrections from correction sources 112 as a component of the accuracy value for the accuracy values. Each accuracy value may be a composite of multiple attributes, including signal strength, number of corrections applied, latency, standard deviation, and/or other various attributes. In some examples, the comparison of accuracy values by the PPP solution selector 130 may include evaluating single attributes, multiple attributes, and/or accuracy values (e.g., composite scores).

In some embodiments, determining the first accuracy value associated with the first positional data at block 340 may include determining, by the one or more processors, if the first attribute of the first correction source satisfies a first attribute threshold. That is, the receiver 120 may analyze positional data to assess whether the first correction data or correction source meets predefined or dynamic performance thresholds corresponding to accuracy values and/or attributes such as latency. For example, the PPP solution selector 130 may evaluate the first positional data to determine if it satisfies the first attribute threshold for acceptable performance. Further, determining the first accuracy value associated with the first correction source at block 350 may include, responsive to the first attribute of the first correction source not satisfying the first attribute threshold, determining, by the one or more processors, if the first attribute of the second correction source satisfies a second attribute threshold. For example, the receiver 120 and/or PPP solution selector 130 may compare the latency associated with the second correction source or second positional data to determine if the second correction source provides an improvement (e.g., 50% improvement or any other value) over the first correction source.

In some embodiments, determining the first accuracy value associated with the first correction source at block 350 may include, responsive to the first attribute of the first correction source not satisfying the second attribute threshold, determining, by the one or more processors, if the first correction source is a default correction source. For example, the receiver 120 may evaluate whether the first correction source is configured as the default system for navigational correction by analyzing a priority list. That is, the PPP solution selector 130 may access stored configurations to determine if the first correction source, which may be a commercial system, is prioritized over a second correction source, which may be an open-source system. Further, determining the first accuracy value associated with the first correction source at block 350 may include, responsive to determining that the first correction source is not the default correction source, selecting, by the one or more processors, the second correction source for navigational correction. For example, the receiver 120 may activate the second correction source by selecting the second correction source for applying corrections to the navigation data, processing the positional data provided using the second correction source, outputting the data to a user interface (e.g., user interface 140), or using the positional data internally to update tracking calculations. In some examples, the PPP solution selector 130 may facilitate the selection by transitioning from the first correction source to the second correction source, processing corrections and positional data from the second correction source, and/or by routing the data through appropriate subsystems (e.g., correction processors 124, PPP engines 126, etc.) to maintain positional accuracy.

In some embodiments, the method 300 may further include, in determining the first positional data and the second positional data, executing, by one or more processors, a first navigation algorithm using the navigation data and the first correction data and a second navigation algorithm using the navigation data and the second correction data. For example, the PPP engine 126a can use a first navigation algorithm with the navigation data and first corrections as input to output the first positional data, and the PPP engine 126b can use a second navigation algorithm with the navigation data and second corrections as input to output the second positional data. In various embodiments, the first and second navigation algorithms can include the same or different algorithms. Further, the one or more processors may be configured to apply additional navigation algorithms in embodiments including three or more correction sources.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer-readable storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “processor” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks, distributed ledger networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any implementations or of what may be claimed, but rather as descriptions of features specific to particular implementations of particular implementations. Certain features that are described in this specification in the context of separate implementations can also be carried out in combination or in a single implementation. Conversely, various features that are described in the context of a single implementation can also be carried out in multiple implementations, separately, or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, by one or more processors, navigation data from a navigation system;
receiving, by the one or more processors, first correction data from a first correction source and second correction data from a second correction source;
determining, by the one or more processors, first positional data based on the navigation data and the first correction data and second positional data based on the navigation data and the second correction data;
determining, by the one or more processors, a first accuracy value associated with the first positional data and a second accuracy value associated with the second positional data; and
selecting, by the one or more processors, one of the first correction source and the second correction source for navigational correction based, in part, on at least one of the first accuracy value and the second accuracy value.

2. The computer-implemented method of claim 1, wherein the first accuracy value corresponds to a standard deviation of the first positional data.

3. The computer-implemented method of claim 1, wherein the first accuracy value corresponds to a latency of the first positional data.

4. The computer-implemented method of claim 1, further comprising:
applying, by the one or more processors, a first correction of the first correction data to the first positional data and a second correction of the second correction data to the second positional data.

5. The computer-implemented method of claim 1, further comprising:
receiving, by the one or more processors, a first attribute of the first correction source and the second correction source; and
receiving, by the one or more processors, a second attribute of the first correction source and the second correction source.

6. The computer-implemented method of claim 5, wherein the first attribute is a latency of the first positional data and the second positional data and the second attribute is a standard deviation of the first positional data and the second positional data.

7. The computer-implemented method of claim 5, wherein determining the first accuracy value associated with the first positional data comprises:
determining, by the one or more processors, if the first attribute of the first correction source satisfies a first attribute threshold;
responsive to the first attribute of the first correction source not satisfying the first attribute threshold, determining, by the one or more processors, if the first attribute of the second correction source satisfies a second attribute threshold;
responsive to the first attribute of the first correction source not satisfying the second attribute threshold, determining, by the one or more processors, if the first correction source is a default correction source; and
responsive to determining that the first navigation system is not the default correction source, selecting, by the one or more processors, the second correction system for navigational correction.

8. The computer-implemented method of claim 1, further comprising:
executing, by the one or more processors, a first navigation algorithm using the navigation data and the first correction data and a second navigation algorithm using the navigation data and the second correction data.

9. A vehicle comprising:
one or more processors configured to:
receive navigation data from a navigation system;
receive first correction data from a first correction source and second correction data from a second correction source;
determine first positional data based on the navigation data and the first correction data and second positional data based on the navigation data and the second correction data;
determine a first accuracy value associated with the first positional data and a second accuracy value associated with the second positional data; and
select one of the first correction source and the second correction source for navigational correction based, in part, on at least one of the first accuracy value and the second accuracy value.

10. The vehicle of claim 9, the one or more processors further configured to apply a first correction of the first correction data to the first positional data and a second correction of the second correction data to the second positional data.

11. The vehicle of claim 9, the one or more processors further configured to:
receive a first attribute of the first correction source and the second correction source; and
receive a second attribute of the first correction source and the second correction source.

12. The vehicle of claim 11, wherein the first attribute is a latency of the first positional data and the second attribute is a standard deviation of the first positional data.

13. The vehicle of claim 11, the one or more processors further configured to, in determining the first accuracy value associated with the first positional data:
determine if the first attribute of the first correction source satisfies a first attribute threshold;
responsive to the first attribute of the first correction source not satisfying the first attribute threshold, determine if the first attribute of the second correction source satisfies a second attribute threshold;
responsive to the first attribute of the second correction source not satisfying the second attribute threshold, determine if the first correction source is a default correction source; and
responsive to determining that the first correction source is not the default correction source, select the second correction source for navigational correction.

14. The vehicle of claim 9, the one or more processors further configured to, in determining the first positional data and the second positional data, execute a first navigation algorithm using the navigation data and the first correction data and a second navigational algorithm using the navigation data and the second correction data.

15. A system comprising:
a receiver configured to:
receive navigation data from a navigation system;
receive first correction data from a first correction source and second correction data from a second correction source; and
one or more processors configured to:
determine first positional data based on the navigation data and the first correction data and second positional data based on the navigation data and the second correction data;
determine a first accuracy value associated with the first positional data and a second accuracy value associated with the second positional data; and
select one of the first correction source and the second correction source for navigational tracking based, in part, on at least one of the first accuracy value and the second accuracy value.

16. The system of claim 15, wherein the first accuracy value corresponds to a standard deviation of the first positional data.

17. The system of claim 15, wherein the first accuracy value corresponds to a latency of the first positional data.

18. The system of claim 15, the one or more processors further configured to apply a first correction of the first correction data to the first positional data and a second correction of the second correction data to the second positional data.

19. The system of claim 15, the receiver further configured to:
receive a first attribute of the first correction source and the second correction source; and
receive a second attribute of the first correction source and the second correction source.

20. The system of claim 15, the receiver further configured to execute a first navigation algorithm using the navigation data and the first correction data and a second navigation algorithm using the navigation data and the second correction data.
